(19) United States
(12) Patent Application Publication
(10) Pub. No.: US 2021/0076212 A1
(43) Pub. Date: Mar. 11, 2021

(54) RECOGNIZING USERS WITH MOBILE APPLICATION ACCESS PATTERNS LEARNED FROM DYNAMIC DATA

(71) Applicant: Carrier Corporation, Palm Beach Gardens, FL (US)

(72) Inventors: Devu Manikantan Shila, West Hartford, CT (US); Kunal Srivastava, Newington, CT (US); Paul C. O'Neill, New Britain, CT (US)

(21) Appl. No.: 17/041,736

(22) PCT Filed: Jan. 24, 2019
(86) PCT No.: PCT/US19/14909

§ 371 Date: Sep. 25, 2020

Related U.S. Application Data
(60) Provisional application No. 62/648,476, filed on Mar. 27, 2018.

(51) Int. Cl. H04W 12/06; H04L 29/06

(52) U.S. Cl. CPC H04W 12/0605; H04W 88/02; H04L 63/0861

(57) ABSTRACT

A method of continuous user authentication on a mobile device including: establishing a baseline model generated based on acquiring dynamic data associated with the mobile device, deploying at least one of a training app or a baseline model to the mobile device, and generating a user detection model based on a baseline model and at least one behavior model plurality of behavior models updated by dynamic data associated with the mobile device collected while an authorized user employs the mobile device. The method also includes deploying the user detection model to the mobile device if the user detection model was remotely generated, measuring further dynamic data to predict behaviors in the user detection model while a user operates the mobile device, and determining if a user is an authorized user based on how closely measured behaviors match the trained behaviors in the user detection model.

### FEDERALLY SPONSORED RESEARCH AND DEVELOPMENT

This invention was made with Government support under contract number D15PC00155 awarded by the United States Department of Homeland Security. The Government has certain rights in the invention.

### TECHNICAL FIELD

Embodiments relate generally to applications for recognition and authentication of users of a mobile device based on application access patterns learned from dynamic data. More particularly, to initial or continuous authentication schemes for a user of a mobile device based on user profiles established based on dynamic data.

### DESCRIPTION OF RELATED ART

Personal electronic devices or mobile phones and there applications are prolific and widespread. Such electronic devices can provide a user with wireless phone access, Internet access, the ability to perform online transactions (e.g., on-line shopping, on-line banking, etc.) as well as other applications such as finding maps to particular locations, among many other things. Widespread use and application of electronic devices that are available today increase user productivity and quality of life.

In the many industries, enhancing customer satisfaction is a priority. Faced with increased industry competition, many operators and retailers are looking for smarter ways to maximize customer satisfaction, improve customer services, and generate more revenue. Expanding how customers access available facilities and services has proven to be a successful strategy. By way of a non-limiting example, electronic devices such as televisions, controllers user computers, user mobile devices, tablets, and the like play an important role in providing interfaces, authentication, and implementing services. Likewise such devices facilitate providing access to and authentication or verification of user identity in advance of providing access to a facility or providing such services. Users are increasingly using a variety of apps on their personal mobile devices facilitate to access to building spaces, define preferences, investigate, request, pay for and receive services. However, such services may require a different app for each service requested which can become cumbersome and burdensome.

Unfortunately, electronic devices (and especially mobile devices) are also susceptible to loss, theft, or unauthorized use. Electronic devices often carry private, confidential, and/or difficult-to-replace data, and the loss of such data further compounds the loss of the electronic device. Additionally, the authorized user of a lost or stolen electronic device may have to deal with ramifications such as the misuse of information or someone else gaining access to information stored on the mobile device. Furthermore, electronic devices are often used to run diverse applications that originate from many sources, which can sometimes lead to users unknowingly installing applications with malicious intent (e.g., malware) onto electronic devices. Such malware may impersonate the authorized user, send unauthorized messages (e.g., to conduct transmissions that debit the telecommunication account associated with the electronic device, usually in an attempt to generate revenue for the attacker), steal personal data, or engage in other malicious and/or unauthorized activity.

Previous attempts have been made to prevent unauthorized use or otherwise stop attacks against electronic devices. For example, some electronic devices are equipped with locking features that require a code or personal identification number (PIN) to unlock the electronic device. Unfortunately, many users do not utilize such authorization schemes such that locking features tend to be ineffective, and moreover, thieves can easily overcome such authorization schemes because unlock codes tend to be short and predictable so as to be memorable to users. Some more sophisticated user authentication solutions may be cumbersome, or inadequate for users to fully realize the benefits of the mobile devices. For example, some result in degraded user experiences (requiring users to authenticate multiple times when the device is used), lack of user-specific service access rights, poor security practices, insufficient security, lack of continuous authentication and poor performance of biometric solutions. Moreover, many existing techniques also have limitations. For example, gait based techniques cannot identify the owner of the device, if the user is not performing any activity, while solutions using touch dynamics, keystroke dynamics require modifications to existing app to understand user touch and keystroke patterns.

Accordingly, with the ubiquity of electronic devices and the ever-present threat that electronic devices may potentially be stolen or subject to unauthorized use, improved techniques to improve user identification/authentication, detect electronic device theft, and/or unauthorized usage are desired. As such, it would be advantageous to resolve these challenges with means of leveraging the processing and sensing capabilities of mobile and wearable devices to create user-specific unique signatures based on behavioral traits that can enable usable security.

### BRIEF SUMMARY

Described herein in an embodiment is a method of continuous user authentication on a mobile device including: establishing a baseline model generated based on acquiring dynamic data associated with the mobile device, deploying at least one of a training app or a baseline model to the mobile device, and generating a user detection model based on a baseline model and at least one behavior model plurality of behavior models updated by dynamic data associated with the mobile device collected while an authorized user employs the mobile device. The method also includes deploying the user detection model to the mobile device if the user detection model was remotely generated, measuring further dynamic data to predict behaviors in the user detection model while a user operates the mobile device, and determining if a user is an authorized user based on how closely measured behaviors match the trained behaviors in the user detection model.

In addition to one or more of the features described above, or as an alternative, further embodiments may include that at least one behavior model of a plurality of behavior models includes user gestures associated with using the mobile device.

In addition to one or more of the features described above, or as an alternative, further embodiments may include that the plurality of user gestures associated with using the mobile device includes at least one of a tap to select, a swipe, a scroll, and a pinch.

In addition to one or more of the features described above, or as an alternative, further embodiments may include that the behavior model of a plurality of behavior models includes: at least one of unlocking the mobile device, entering data into the device, answering a call on the mobile device, patterns with respect to the keystrokes that a certain operator makes to enter input into the device, and biometrics.

In addition to one or more of the features described above, or as an alternative, further embodiments may include that the biometrics include at least one of heart rate, respiration rate, and skin conductivity.

In addition to one or more of the features described above, or as an alternative, further embodiments may include that the baseline application access model is updated on a plurality of baseline application models from other users.

In addition to one or more of the features described above, or as an alternative, further embodiments may include acquiring dynamic data associated with the mobile device further includes: acquiring raw dynamic sensor data from the mobile device for a selected duration; extracting time and frequency domain features in the raw dynamic sensor data; and building at least one behavior model of a plurality of behavior models by applying extracted time and frequency domain features to a learning algorithm.

In addition to one or more of the features described above, or as an alternative, further embodiments may include that the dynamic data includes at least one of rotational accelerations, rotational rates, rotation, translational accelerations, translational velocities, and position data, associated with the mobile device.

In addition to one or more of the features described above, or as an alternative, further embodiments may include that the position data is based on at least one of accelerometer, gyroscope and GPS data.

In addition to one or more of the features described above, or as an alternative, further embodiments may include that the baseline application access model is an aggregate of a plurality the baseline application access models associated with a plurality of user devices.

In addition to one or more of the features described above, or as an alternative, further embodiments may include that the baseline application access model, is aggregated on a remote server based on a plurality the baseline application access models associated with a plurality of user devices.

In addition to one or more of the features described above, or as an alternative, further embodiments may include that the user detection model, is an aggregate of a plurality user detection models.

In addition to one or more of the features described above, or as an alternative, further embodiments may include that the user detection model, is aggregated on a remote server.

In addition to one or more of the features described above, or as an alternative, further embodiments may include that the at least one behavior model is independent of user application touch sensor data.

In addition to one or more of the features described above, or as an alternative, further embodiments may include establishing a trust score associated with the determining, the trust score providing a weighting of how closely the measured behaviors match the trained behaviors in the user detection model.

In addition to one or more of the features described above, or as an alternative, further embodiments may include that a trust score greater than a selected threshold indicates a sufficient match for authentication.

In addition to one or more of the features described above, or as an alternative, further embodiments may include taking security precautions with the user device if the user is identified as not an authorized user.

In addition to one or more of the features described above, or as an alternative, further embodiments may include that the security precautions include at least one of sounding an alarm, locking the mobile device, placing a call to law enforcement, shutting the mobile device off.

In addition to one or more of the features described above, or as an alternative, further embodiments may include acquiring data from a wearable device and establishing at least one behavior model of the plurality of behavior models generated based on the data associated with the wearable device.

In addition to one or more of the features described above, or as an alternative, further embodiments may include that the data associated with the wearable device is biometric data associated with the user.

Also described herein in an embodiment is a system for continuous user authentication on a mobile device. The system includes a user device, a server operably connected to the user device, and at least one of the server and the user device configured to execute a method of continuous user authentication on the mobile device. The method includes establishing a baseline application access model, the baseline application access model based on at least one behavior model of a plurality of behavior models generated based on acquiring dynamic data associated with the mobile device, deploying at least one of a training app or a baseline application model to the mobile device, and generating user detection model, the user detection model based on at least one baseline application access model and at least one behavior model of the plurality of behavior models updated by dynamic data associated with the mobile device collected while an authorized user employs the mobile device to access an application. The method also includes deploying the user detection model to the mobile device if the user detection model was remotely generated, measuring further dynamic data to predict behaviors in the user detection model while a user operates the mobile device, and determining if a user is an authorized user based on how closely measured behaviors match the trained behaviors in the user detection model.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded of the described embodiments is particularly pointed out and distinctly claimed in the claims at the conclusion of the specification. The foregoing and other features, and advantages of the described embodiments are apparent from the following detailed description taken in conjunction with the accompanying drawings in which:

FIG. 1 depicts a simplified diagrammatic view of the system and interfaces for implementing the methodology of continuous user authentication in accordance with an embodiment;

FIG. 2 is a depiction of a cloud computing environment as may be employed in accordance with an embodiment;

FIG. 3 depicts a simplified block diagram of a computing system as may be implemented in a user device in accordance with an embodiment;

FIG. 4 depicts a flowchart of an example method of continuous user authentication in accordance with an embodiment; and

FIG. 5 depicts a flowchart of an example method of acquiring data for continuous user authentication in accordance with an embodiment.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended. The following description is merely illustrative in nature and is not intended to limit the present disclosure, its application or uses. It should be understood that throughout the drawings, corresponding reference numerals indicate like or corresponding parts and features. As used herein, the term controller refers to processing circuitry that may include an application specific integrated circuit (ASIC), an electronic circuit, an electronic processor (shared, dedicated, or group) and memory that executes one or more software or firmware programs, a combinational logic circuit, and/or other suitable interfaces and components that provide the described functionality.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

Embodiments related to a method for authenticating a user with a mobile device based on the way user accesses, interfaces, and utilizes various mobile applications. Advantageously the described method enables continual, strong and user-friendly context-aware authentication for data protection and service usage control. The method is based on integrating existing service access technologies with mobile device sensors and perception systems using our novel techniques for multi-sensor fusion, multivariate time series classification and segmentation algorithms, risk-based dynamic access control inference engine and context-aware remote management. Uniquely, rather than employing data associated with the individual applications a profile for the user is built from dynamic data, e.g., accelerometer and gyroscope data, as the user employs various applications on the mobile device. In the described embodiments, two techniques are employed. First, the raw dynamic data e.g., accelerometer and gyroscope data is collected from the mobile device to understand if the user is scrolling, tapping or zooming the app (referred to application access pattern), and the like. Second, a learning algorithm is employed to learn (teach) an individual model per user application access pattern. This model is then used to predict a trustworthiness score of user while accessing the applications. Advantageously, such an approach does not rely on receiving and understanding data from individual applications and therefore avoids privacy concerns as no access to particular user data or data in apps is required. In other words, the approach employed in the described embodiments does not user or receive any actual data from the application that employed by the user. As such, no actual data associated with the application the user is employing is passed from the user app to authentication methodology or application. This is very privacy aware solution as it only observes raw sensor data and not any text or logs in the mobile device.

Advantageously, the described embodiments provide a passive technique that will recognize a user and provide user authentication continuously and essentially real time based on dynamic data associated with the way applications on a control device or mobile device are accessed. Moreover the described embodiments facilitate preventing aggressive malicious mobile app/user from accessing sensitive resources and facilitate the identification and distinguishing of individual users to permit customization of services based on identity Such an approach in an embodiment can identify how to learn the to identify and authenticate users based on the raw accelerometer and gyroscope data collected. Fortunately, these datasets can be easily collected without requiring modification to the system protect from lost or stolen devices.

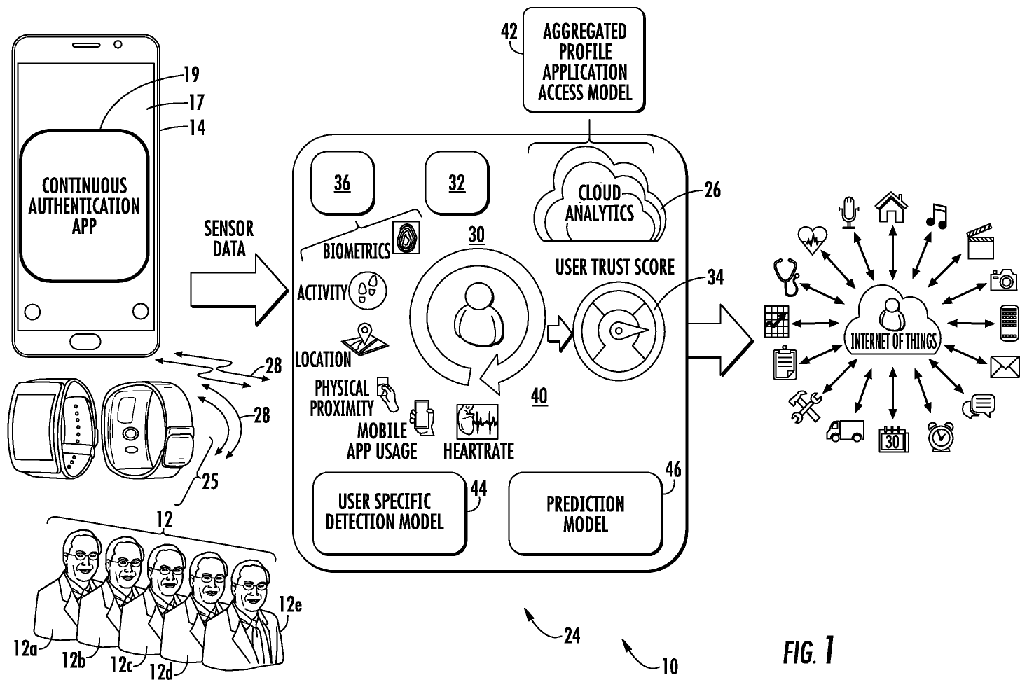

Referring now to the drawings, FIG. 1 illustrates a diagrammatic overview of a system 10 for recognition and authentication of users 12 based on access patterns. In particular, access patterns learned from dynamic data measured while a user 12 uses a user device 14 or accesses one or more applications, or even a learning application on a user device 14. Dynamic data includes position, rotation and acceleration measured by dynamic sensor(s) in the user device 14. The dynamic data may include three-axis translational and rotational accelerations, three-axis translational and rotational velocities, three axis rotation angles, and instantaneous positions, and geographic positions. The system 10 may include a controller or server denoted generally as 24 that is employed to interface with a user device 14 and execute processes for recognition and authentication in accordance with the embodiments described herein. In addition, some, or all of the functionality provided may be based on methods and processes executed locally or remotely such as on a local or remote server 24 and/or cloud computing environment 26. As will be appreciated the cloud computing environment 26 could include a local or remote server 24, or the server 24 and cloud computing environment 26 could be entirely remote. The system 10 may also include a local and remote communication network and system, shown generally as 28 for facilitating communication and control of various features in the system 10 as well as for facilitating communication between a user device 14, server 24, and the cloud computing environment 26, other components and sensors in the system and the like. Likewise, the system 10 may also include one or more application(s) (app) 19 operable on the user device 14, that permits and facilitates the user 12 to enter and receive information and for user device 14 to communicate with, interface with, and control selected aspects of system 10. The app 19 and the user device 14 may include a user interface 17 to enable the user 12 to interface with the user device 14 and the app 19 being executed thereon. In an embodiment, the app 19 may be employed by the user 12, for example to facilitate user authentication and access permissions to the building system. The app 19 may also facilitate establishing user preferences associated with the system 10 and methods described herein.

Server 24 may be part of a cloud computing environment 26. Cloud computing is a widely adopted and evolving concept. Generally, cloud computing refers to a model for enabling ubiquitous, convenient, and on-demand access via Internet to shared pools of configurable computing resources such as networks, servers, storages, applications, functionalities, and the like. There are a number of benefits associated with cloud computing for both the providers of the computing resources and their customers. For example, customers may develop and deploy various business applications on a cloud infrastructure supplied by a cloud provider without the cost and complexity to procure and manage the hardware and software necessary to execute the applications. The customers do not need to manage or control the underlying cloud infrastructure, e.g., including network, servers, operating systems, storage, etc., but still have control over the deployed applications. On the other hand, the provider's computing resources are available to provide multiple customers with different physical and virtual resources dynamically assigned and reassigned according to clients' load. Further, cloud resources and applications are accessible via the Internet.

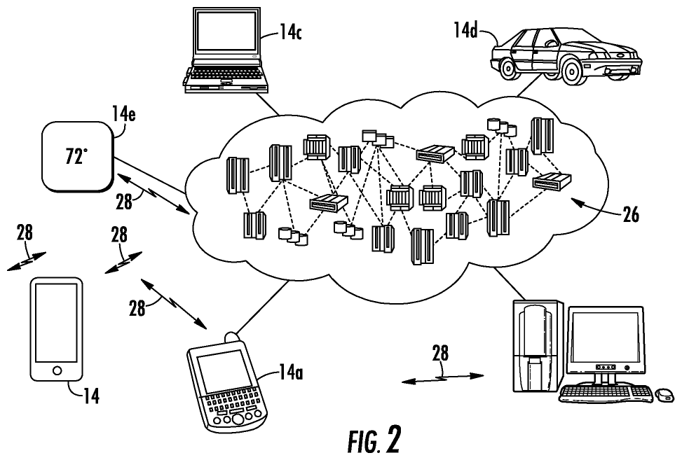

Referring now to FIG. 2, an illustrative cloud computing environment 26 is depicted. As shown, cloud computing environment 26 includes one or more cloud computing nodes, such as processing or communication nodes e.g., servers 24 (FIG. 1) with which, user devices (generally referred to as 14), computing devices and controllers all denoted in various configurations as 14a-e may communicate. Cloud computing nodes 24 may communicate with one another and/or be grouped (not shown) physically or virtually, in one or more networks, such as Private, Community, Public, or Hybrid clouds, or in one or more combinations thereof. This allows cloud computing environment 26 to offer infrastructure, platforms and/or software as services for which a cloud consumer does not need to maintain or minimize resources at a local computing device level. It is understood that the types of user/computing devices 14 shown in FIG. 2 are intended to be illustrative only and that computing nodes and cloud computing environment 26 can communicate with any type of computerized device over any type of network and/or network addressable connection (e.g., using a web browser).

The computing devices 14a-e such as user device 14 may be any form of a mobile device (e.g., smart phone, smart watch, wearable technology, laptop, tablet, etc.). The user device 14 can include several types of devices, in one instance, even a fixed device, e.g. a keypad/touch screen affixed to a wall in a building corridor/lobby, such as building system controllers. In other words, the server 24 and the user device 14 can all be computing devices 14a-e. It should be appreciated that the servers 24 are typically part of the installed building system infrastructure, while the user device 14 is typically owned and used by the user 12, service man, homeowner, and the like. The term “user device” 14 is used to denote all of these types of devices as may be employed by the user 12. For example, in an embodiment, the computing devices 14 could be, a personal digital assistant (PDA) or cellular telephone tablet 14a, such as user device 14, desktop computer/terminal/server 14b, laptop computer 14c, a vehicle 14d, or a control panel of some sort for a building system 14e, and the like. User devices 14a-e may also be configured to communicate with each other or a variety of sensors directly or via communication network 28.

The computing devices, 14a-e such as user device 14, as well as other components of the system 10 can communicate with one another, in accordance with the embodiments of the present disclosure, e.g., as shown in FIG. 1. For example, one or more user devices 14 or a server 24 may communicate with one another when proximate to one another (e.g., within a threshold distance). The user device 14 and server 24 may communicate over one or more communication networks 28, (e.g., a communication bus) that may be wired or wireless. Wireless communication networks can include, but are not limited to, Wi-Fi, short-range radio (e.g., Bluetooth®), near-field (NFC), infrared, cellular network, etc. In some embodiments, user device 14 (e.g., the computing devices 14a-14e may include, or be associated with (e.g., communicatively coupled to) one or more other networked building elements (not shown), such as computers, beacons, other system controllers, bridges, routers, network nodes, etc. The networked elements may also communicate directly or indirectly with the user devices 14 using one or more communication protocols or standards (e.g., through the network 28). For example, the networked element may communicate with the user device 14 using near-field communications (NFC) and thus enable communication between the user device 14 and any other components in the system 10 when in close proximity to the user device 14 (NFC is a short range wireless protocol). Or, for example, the networked element may communicate with the user device 14 using Bluetooth and thus communicate a unique ID and enable communication between the user device 14 and any other components in the system 10 from a further distance. The network 28 may be any type of known communication network including, but not limited to, a wide area network (WAN), a local area network (LAN), a global network (e.g. Internet), a virtual private network (VPN), a cloud network, and an intranet. The network 28 may be implemented using a wireless network or any kind of physical network implementation known in the art. The user devices and/or the computing devices 14 may be coupled to the server 24, through multiple networks (e.g., cellular and Internet) so that not all user devices and/or the computing devices 14 are coupled to the any given server 24 or component through the same network 28. One or more of the user devices 14 and servers 24 may be connected in a wireless fashion. In one non-limiting embodiment, the network 28 is the Internet and one or more of the user devices 14 executes a user interface application (e.g. a web browser, mobile app) to contact and communicate through the network 28.

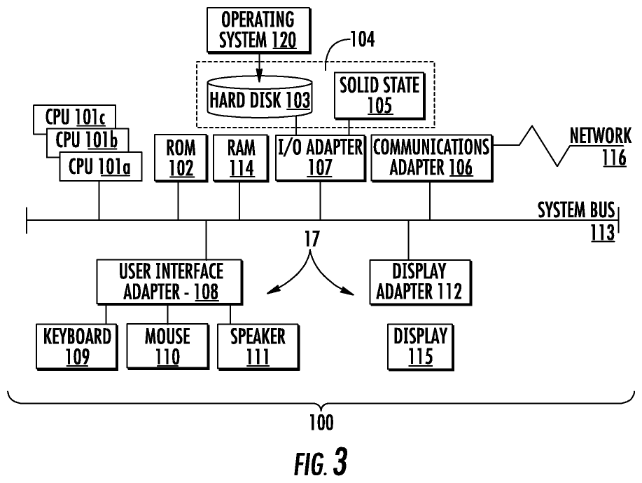

Referring to FIG. 3, the computing devices 14a-e, including user device 14, may include a processing/computing system 100 including a processor, memory, and communication module(s), as needed to perform the functions of recognition and authentication based on dynamic data in accordance with an embodiment. In one embodiment, the computing devices 14a-e, including user device 14 and servers 24 each may include a computing system 100 having a computer program stored on nonvolatile memory to execute instructions via a microprocessor related to aspects of recognition and authentication based on dynamic data in accordance with the embodiments described herein.

In an embodiment, the computing system 100 has one or more processing units (processors) 101a, 101b, 101c, etc. (collectively or generically referred to as processor(s) 101). The processor 101 can be any type or combination of computer processors, such as a microprocessor, microcontroller, digital signal processor, application specific integrated circuit, programmable logic device, and/or field programmable gate array. As is conventionally done, the processors 101 are coupled to system memory and various other components via a system bus 113. The memory can be a non-transitory computer readable storage medium tangibly embodied in the user device 14 or server 26 including executable instructions stored therein, for instance, as firmware or mass storage 104. Read only memory (ROM) 102 is coupled to the system bus 113 and may include a basic operating system, which controls certain basic functions of system 100. Random Access Memory (RAM) 114 is also coupled to the system bus 113 and may include a basic storage space to facilitate program execution.

FIG. 3 further depicts an input/output (I/O) adapter 107 and a network or communications adapter 106 coupled to the system bus 113. I/O adapter 107 communicates with hard disk 103 and/or solid state storage 105 or any other similar component. I/O adapter 107, hard disk 103, and solid state storage 105 are collectively referred to herein as mass storage 104. As is conventionally done an operating system 120 for execution on the computing system 100 may be stored in mass storage 104. A communications adapter 106 interconnects bus 113 with an outside network 116 such as and including communications network 28 and the like, enabling computing system 100 to communicate with other such systems. The communications adapter 106 may implement one or more communication protocols as described in further detail herein, and may include features to enable wired or wireless communication with external and/or remote devices separate from the user device 14. The computing device 14a-e including the user device 14 and/or server 24 may further include a user interface, shown generally as 17, e.g., a display screen, a microphone, speakers, input elements such as a keyboard 109 or touch screen, etc. as shown in FIG. 3) as is known in the art. A screen (e.g., a display monitor) 115 is connected to system bus 113 by display adaptor 112, which may include a graphics adapter and a video controller. A keyboard 109, mouse 110, and speaker 111 all interconnected to bus 113 via user interface adapter 108. It should be appreciated that in some embodiments some or all of these elements of the computing system 100 may be integrated. In one embodiment, adapters 107, 106, and 112 may be connected to one or more I/O busses that are connected to system bus 113 via an intermediate bus bridge (not shown). Suitable I/O buses for connecting peripheral devices may also be employed. Additional input/output devices are shown as connected to system bus 113 via user interface adapter 108 and display adapter 112. It should be appreciate that the components of the computing system as described are for illustration purposes only. Features and functions as described may be omitted, integrated, or distributed as desired and as required to suit a particular application.

Referring once again to FIG. 1, in an embodiment, various behaviors, activities, or attributes 32 of a user 12 are monitored. For example, behaviors activities, or attributes 32 (hereinafter behaviors) of a user 12 may include, but not be limited to, biometrics, user activities, location, app usage, user proximity to the user device 14, and user characteristics such as heart rate, respiration and the like. The behaviors 32 are monitored on a user device 14 to generate a profile model 30 associated with an authorized user, e.g., 12a. The behavior models 32 are the employed with a trust score 34 associated with selected actions described in further detail herein may be used to generate the profile model 30 and determine whether a current operator/user 12a-12e using the electronic device 14 is the authorized user 12a. The objective is to distinguish between an authorized user 12a or some other user 12b (e.g., a potential thief who physically stole the electronic device and is now using the device 14, a malicious user 12c who has obtained unlock or other authentication credentials and is improperly using the user device 14, an authorized secondary user 12d such as the authorized user's 12a spouse or child 12e, etc.). More particularly, whereas current approaches to detecting unauthorized usage of a user device 14 tend to measure one or more particular attributes (e.g., a time from device pick-up as sensed with an accelerometer to the time that the user 12 first touches the device 14) and then establish a threshold with respect to the measured attributes to characterize the user 12, which can result in thresholds that are either excessively sensitive or excessively lax.

In various embodiments, the electronic device 14 may comprise an observation function or process 36 configured to capture one or more behavior features 32 that represent salient behaviors 32 observed on the electronic device 14 based on dynamic data captured while the user 12 is exhibiting such behaviors. Furthermore, additional example behaviors 32 that the observation function 36 may observe may comprise information based on an events and notifications (e.g., push notifications received at the user device 14), actions that may include, without limitation, unlocking the user device 14, entering data into the user device 14, answering a call, etc., keystroke-based identity profiles (e.g., positions, timings, and patterns with respect to the keystrokes that a certain operator makes to enter input into the user device 14), application installation and usage frequencies, and so on. Other behaviors 32 observed may be related to biometrics for the user 12. For example, as a user 12 accesses the user device 14, biometric information associated with that particular user 12 may be collected and recorded. Such biometric data may include, but not be limited to heart rate, respiration, skin conductivity, respiration, and the like. Accordingly, those skilled in the art will appreciate that the observation function 36 may broadly capture the behaviors 32 to represent any suitable behaviors 32 that can be observed on the electronic device 14 and attributed to a user 12 and more particularly, a certain user 12a, 12b, and the like. In various embodiments, the behaviors 32 observed and generated at the observation process 36 may then be analyzed by executing one or more machine learning algorithms 40 to cluster the behavior 32 and thereby construct a behavior models 30 related to the observed behaviors 32.

Accordingly, in various embodiments, the observation function may be configured to monitor or otherwise collect local behavioral information on the electronic device 14 through one or more application program interface (API) calls and minimal instrumentation at one or multiple levels in an operating system stack, whereby the observation function may utilize fast and efficient in-memory processing to monitor, measure, or otherwise observe behavioral information associated with the electronic device 14 and generate one or more behaviors models 34 that describe the observed behaviors 32 in concise or consolidated terms.

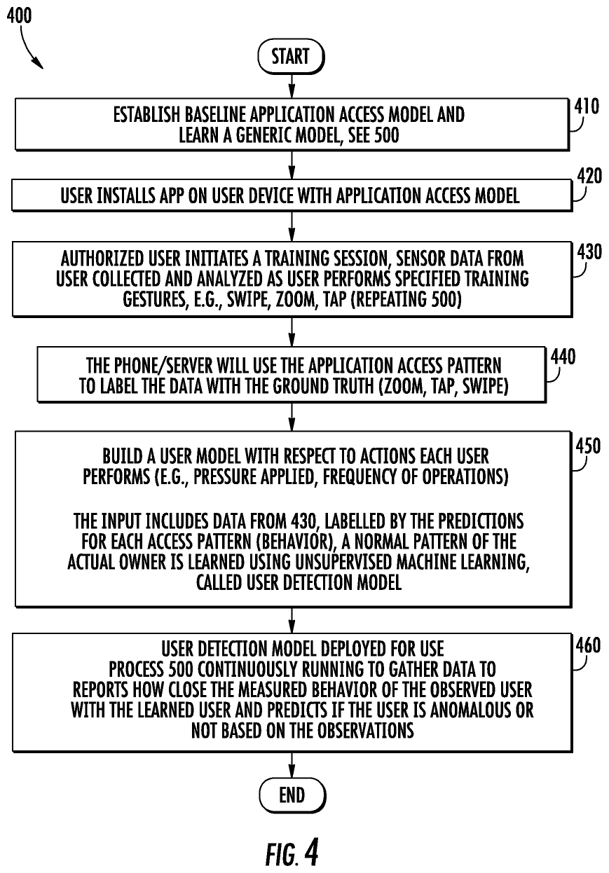

Turning now to FIG. 4 as well, in an embodiment the processes of continuous authentication of the described embodiments are functionally segregated into three processes. First a development of a baseline application access model based on a variety of collective behavior models associated with a user's actions on a user device 14. Second, development of a user detection model based on initial training of application access model with a known authorized user e.g., 12a. Finally prediction and determination of an authorized or unauthorized user 12 by collecting data and evaluating the data in the user detection models 44 to identify how closely the current user's measured behaviors 32 match those established during the training. A close match of behaviors 32 is indicative of identifying an authorized user e.g., 12a.

For example, in an embodiment the observation function 36 may be employed in multiple phases of a process for continuous authentication as described herein. In a first phase during an initialization or “training” phase, the observation function 36 may monitor behaviors 32 on the device 14 over a predefined time period comprising (e.g., several) minutes, hours days, wherein the behaviors 32 observed over the time period may be mapped and recorded. As such, the observation function 36 may extract the behavior models 30 that represent the observed behaviors over the time period, wherein the extracted behavior models 30 each represents a behavior 32 type (e.g., notifications, location updates, etc.) and each entry in the behavior models 30 represents one observed behavior 32 having the respective type.

In various embodiments, the electronic device 14 may then store the local profile application access model 30 in a local model repository on the electronic device 14. In addition, the electronic device 14 may upload the local profile application access model 30 to a server 24 e.g., cloud computing environment 26, which may further receive profile application access models 30 uploaded from various other devices 14. The server 24 or cloud computing environment 26 may then execute algorithms on the local profile application access model(s) 30 uploaded from the electronic device 14 in combination with the profile application access models 30 uploaded from the various other devices 14 to create an aggregate baseline profile application access models 42 (FIG. 1). This baseline profile application access model 42 provides a baseline generic model for all the behaviors 32. Furthermore, the server/cloud computing environment 26 may compare the local profile application access model 30 uploaded from the electronic device 14 (and the profile application access models 30 uploaded from the various other devices 14) to the baseline profile application access models 42 to determine the baseline profile model 30 closest to each respective profile model 30 that was uploaded to and clustered on the server/cloud computing environment 26 to form the baseline profile models 42. For example, in various embodiments, the server/cloud computing environment 26 may compare the local profile application access models 30 uploaded thereto with each baseline profile application access model 42 to calculate one or more distance metrics that quantify a semantic and/or syntactic similarity between the local profile models 30 and each respective baseline profile application access model 42. Accordingly, the server/cloud computing environment 26 may register each local profile application access model 30 as a member within the particular baseline profile application access model 42 closest to the respective local profile application access model 30, as determined according to the distance metrics (e.g., distance metrics based on aggregate or global rule comparisons that can quantify similarities in syntactic form and individual or content-based rule comparisons that can quantify similarities in semantic meaning). Accordingly, depending on the particular distance metric(s) used, the server/cloud computing environment 26 may identify one baseline profile application access model 42 closest to each respective local profile application access model 30 such that each local profile model 30 may be a member in the closest baseline profile application access model 42. Furthermore, in various embodiments, the server/cloud computing environment 26 may track the membership in the baseline profile application access models 42 over time to create and maintain anonymous user behavior profiles (not shown).

In various embodiments, the electronic device 14 (and other user devices 14 associated with other profile application access models 30) may then download the baseline profile application access models 42 from the server/cloud computing environment 26 and store the downloaded baseline profile application access models 42 together with the initial local profile application access model 30 on a specific user device 14. Furthermore, the user device 14 may store information to indicate the current baseline profile application access model 42 in which the local profile application access model 30 was assigned membership. As such, the initial local profile application access model 30 generated on the device 14, the baseline profile application access models 42 downloaded from the server/cloud computing environment 26, and the information stored indicating the current membership associated with the local profile application access model 30 can be used to authenticate a current user 12 or operator associated with the electronic device 14 and thereby detect potential theft, unauthorized usage, authorized operator changes, etc.

More particularly, in an embodiment, the observation function 36 may continue to monitor user behavior(s) 32 on the electronic device 14 in a substantially continuous and similar manner to that described above. However, whereas the observation function 36 monitored the user behavior 32 over an “extended” selected period during the initialization or “training” phase used to create the initial local profile application access model 30 and the baseline profile application access models 42, in this instance the observation function 36 may monitor the user behavior(s) 32 on the device 14 over smaller time periods (e.g., on the order of a few minutes) during subsequent phases that are directed to particular user authentication, identity verification, theft detection, operator change detection, etc. Accordingly, as described above, the process may be continuously performed as described above to refine the local profile application access model 30.

### Prediction Models

In various embodiments, a comparison may then be conducted to compare the new local profile models 30 that are rebuilt as described above to each baseline profile model 42 downloaded from the server/cloud computing environment 26. For example, in various embodiments, a new local profile model 30 may be compared to a downloaded baseline profile models 42 according to the various distance metrics described in further detail above. As such, once again the comparison facilitates determining a net/normalized distance from the local profile model 30 to each baseline profile model 42 to quantify syntactic and/or semantic similarities therebetween and identify the baseline profile model 42 closest to the local profile model 30 accordingly. Moreover, in various embodiments, the comparison may then generate an identity authentication of a user 12a-12e (or operator) associated with the electronic device 14 as the prior user e.g., 12a, 12c, 12e, who engaged in the behavior 32 during the training phase that resulted in the initial local profile model 30. For example, if the current user or operator 12 is the prior (authorized) user 12a, 12c, 12e, the new profile model 30 from the most recent observation period should still be closest to the baseline profile model 42 that includes the initial local profile model 30 as a member. Accordingly, in response to determining that the (current) new profile model 30 is closest to the baseline profile model 42 that includes the initial local profile model 30 as a member, the identity authentication generated may authenticate the current user 12 identity with a first level of confidence or outlier score (denoted X), which may be expressed according to a percentage depending on the distance from the current profile model 30 and the baseline profile model 42 closest to the original local profile model 30. For example, in various embodiments, the confidence measure or outlier scoreX may be inversely proportional to a difference between the distance between the current profile model 30 and the closest baseline profile model 42 and the distance between the original profile model 30 and the closest baseline profile model 42 (e.g., because the distance metrics range from zero to one, where a zero value indicates the least possible distance and a one value indicates the highest possible distance) Further details regarding the outlier score and determining the trust score for discerning anomalous behaviors is addressed at a later point herein.

However, in response to determining that the current profile model 30 is closest to a different baseline profile model 42 than the original local profile model 30, the identity authentication may indicate a change in user/operator 12 from the original local profile model 30 to an unauthorized user e.g., 12b, 12d, which may cause one or more security based actions to occur on the electronic device 14. For example, possible actions may include having the comparing the current local profile model 30 to local profile models 30 that are associated with one or more authorized users 12a, 12c, 12e (e.g., a spouse or child associated with the primary user 12a), which assumes that sufficient “training” behavior was observed with respect to the other authorized users 12a, 12c, 12e to create local profile models 30 associated therewith. Accordingly, in response to the comparison determining that the current local profile model 30 in fact, matches the local profile model 30 associated with another authorized user e.g., 12c, the identity authentication may comprise an operator change notification to that effect. Alternatively, where the current local profile model 30 does not match the local profile models 30 associated with any authorized users 12 to a sufficient confidence level (or where there are no authorized secondary users e.g., 12b, 12d that engaged in sufficient training), the identity authentication process may generate a message communicated internally within the electronic device 14 and/or to the external server/cloud computing environment 26 to disable the user device 14 and initiate recovery and/or protective actions. For example, the identity authentication may cause an internal transmitter on the device 14 to broadcast a current or most recent position fix to thereby assist in finding or otherwise recovering the electronic device 14. In another example, the identity authentication may start an internal procedure to protect data stored on the device 14 and shut the device 14 down to prevent the unauthorized operator 12 from continuing to use the electronic device 14. In another example, the user device 14 may automatically take and store pictures for further investigation.

Accordingly, because the described embodiments support procedures to authenticate a current user or operator 12 associated with the electronic device 14 using profile models 30, 42 that are based on behaviors 32 observed over time, including behaviors 32 associated with other users 12 that provide an external perspective on the local user profile model 30, the model generation and comparison techniques described herein can enable more robust and realistic identity thresholds that may be possible through raw comparisons between discrete individual features.

Turning now to FIG. 4, for a description of the methodology of in accordance with an embodiment. FIG. 4 is a flowchart depicting high level example of a method 400 for recognizing users 12 with mobile application access patterns based on dynamic data of a user device 14 in accordance with an embodiment. In an embodiment, the method 400 initializes at process step 410 with establishing the baseline application access pattern model 30 as described above to establish the aggregate application access model 42. In operation, this model may be employed for the baseline for specific user training. That is, the model 30 is continually updated as an authorized user e.g., 12a, 12c, 12e, continues to teach the model 30.

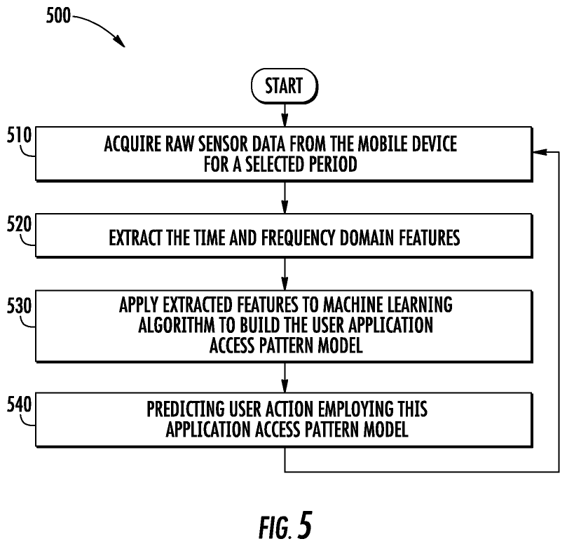

Turning now to FIG. 5 as well, depicting a flow chart of the steps for acquiring the dynamic data and building the baseline application access model 30 as depicted by process 510. In an embodiment, the process 510 initiates with a acquiring the raw dynamic sensor data from the mobile device 14 as a user 12 is conducting the training behaviors 32 as described with respect to process step 410. The data could be received by an application operating on the user device 14, or an application operating remotely, for example on a remote server/cloud computing environment 26. The process continues at process step 520 with extracting time and frequency domain features from the raw data. In an embodiment, the extraction is implemented by dividing the training time period of step 410 into a number of slices “N”, and then extracting the data for each slice. It is desirable to make the slices sufficiently small (of short enough time duration) to ensure robust acquisition for the frequency domain content. In an embodiment, a time slice of 5-10 seconds is employed, though it should be appreciated that other values for the time slices are possible and envisioned. In addition, it is advantageous to have each of the slices overlap slightly to ensure that no data is lost at the boundaries of the slices. In an embodiment, a 105 to 50% overlap is employed, though it should be appreciated that other values are possible particularly depending on the number of slices N selected, their duration, the duration of the training period, and the like. The time and frequency domain features are then applied to the machine learning algorithm as depicted at process step 530 to build the behavior models 32 and formulate the local baseline application access model 30. As described above, this baseline application model 30 may also be aggregated with other baseline application models 30 to create the aggregated baseline application model 42. Finally, as depicted at process step 540, the new baseline application access models 30 and or the aggregated baseline application model 42 is provided to the user device 14 include predictions associates with user behaviors 32. In an embodiment the models include predictions of user gestures on the user device 14 including tap or press, swipe, press and swipe, pinch, and the like.

The method 400 continues at process step 420 with an authorized user 12a, 12c, 12e, employing the baseline application model 30 or the aggregated baseline application model 42 to initiate a user specific training session. In this instance the baseline model 30, (or aggregated baseline model 42) is updated learning further details of a specific authorized user's e.g., 12a, 12c, 12e, behaviors 30. The behavior models 30 for the particular user 12 are then updated to facilitate the continuous authentication as described herein. In an embodiment, as depicted at process step 430, an authorized user 12a, 12c, 12e may employ a training app that facilitates capturing specific user behaviors 32 and the learning (teaching and updating) the baseline access model 30, 42 to form or build a user specific detection model 44. As described above the training app may require a reduced time and processing executing selected operations and gestures. Once again in operation, the learning/updates are accomplished employing process steps 510-540 to gather dynamic data while a given authorized user e.g., 12a, 12c, 12e is completing the training. Once training is completed, the user specific detection model 44 (FIG. 1) has been built, and is available for continuous authentication as depicted at process step 450. It should be appreciated that the training and building of a specific user detection model 44 is accomplished for each authorized user 12a, 12c, and 12e. As a result, there may be a plurality of specific user detection models 44 that are then saved to the user device 14. In another embodiment, it should be appreciated that building the specific user detection model 44 may include only recording the variations from the baseline user model 30, 42 rather than necessarily building and storing separate complete user detection models 44 for each authorized user e.g., 12a, 12c, 12e, for predicting a user's action based on the user specific detection model 44. The prediction is based on building the profiles and models as described above.

After training, the user detection model(s) 44 are deployed on the user device 14 or on the cloud computing environment 26 for use and may readily be employed to predict if a given user 12 is an authorized user e.g., 12a, 12c, 12e, or anomalous and not authorized e.g. 12b, 12d based on the observations as depicted at process step 460 In operation, to carry out the process of conducting the method of continuous authentication, the application on the user device 14 continues process steps 510-540 to gather and process dynamic data collected as various users 12 operated the user device 14. The process 400 then includes comparing the observed behaviors 32 from the data with that of the user authentication model(s) 44 to identify if a particular user 12 is authorized user e.g. 12a, 12c, 12e, or an unauthorized user e.g. 12b, 12d as described further herein. As data is collected and applied to each of the behavior models, this instance the user authentication model(s) 44 a comparison is continually made as the model(s) learn more of the specific behaviors of the users e.g. 12a, 12c, 12e, or an unauthorized user e.g. 12b, 12d. As each user 12a, 12c, 12e, or an unauthorized user e.g. 12b, 12d inputs data, the models generate an outlier score or anomaly score based on how closely the behavior data matches (or how far away from the current model the data is. Outlier scores for various models 44 can be normalized and weighted in different ways and ultimately combined to establish a trust score 34. For example, in an embodiment, for various behaviors and behavior models, a set of normalized outlier scores from model 1, model 2 and model 3 be denoted as (O1, O2, O3 . . . ). Using a simple weighting scheme, the trust score 34=w1*O1+w2*O2+w3*O3 . . . . The trust score 34 is then compared with a user or application defined threshold to output as normal or abnormal user. Using a scheme that flags the most anomalous behavior, as an example, the trust score=max(O1, O2, O3), which suggests that if any of the model(s) indicates an anomaly (i.e. an unauthorized user e.g. 12b, 12d, e.g. 12b, 12d he behavior and user 12 are flagged as an anomaly. While such an approach is the most conservative and directed to most readily identifying unauthorized users e.g. 12b, 12d, other schemes could be employed. For example, the trust score could be established that at least two behaviors would have to be identified as anomalous to then flag a user 12 as an unauthorized user e.g. 12b, 12d.

The technical effects and benefits of embodiments relate to a method and system for authenticating a user with a mobile device based on the way user accesses, interfaces, and utilizes various mobile applications. Advantageously the described method enables continual, strong and user-friendly context-aware authentication for data protection and service usage control. The method is based on integrating existing service access technologies with mobile device sensors and perception systems using our novel techniques for multi-sensor fusion, multivariate time series classification and segmentation algorithms, risk-based dynamic access control inference engine and context-aware remote management. Uniquely, rather than employing data associated with the individual applications a profile for the user is built from dynamic data, e.g., accelerometer and gyroscope data, as the user employs various applications on the mobile device.

The present disclosure may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a hard disk, a random access memory (RAM), a read-only memory (ROM), a portable compact disc (CD), a digital versatile disk (DVD), a memory stick, and the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers, and the like.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of scope and breadth of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the described embodiments in the form disclosed. Many modifications and variations will be apparent to those of ordinary skill in the art without departing from the scope and spirit of the claims. The embodiments have been chosen and described in order to best explain the principles of the inventive concept and the practical application, and to enable others of ordinary skill in the art to understand the scope and breadth of the claims and the various embodiments with various modifications as are suited to the particular use contemplated.

1. A method of continuous user authentication on a mobile device, the method comprising:
establishing a baseline application access model, the baseline application access model based on at least one behavior model of a plurality of behavior models generated based on acquiring dynamic data associated with the mobile device;
deploying at least one of a training app or a baseline application model to the mobile device;
generating a user detection model, the user detection model based on at least one baseline application access model and at least one behavior model of the plurality of behavior models updated by dynamic data associated with the mobile device collected while an authorized user employs the mobile device to access an application;
if the user detection model was remotely generated, deploying the user detection model to the mobile device;
measuring further dynamic data to predict behaviors in the user detection model while a user operates the mobile device; and
determining if a user is an authorized user based on how closely measured behaviors match the trained behaviors in the user detection model.

2. The method of claim 1, wherein at least one behavior model of a plurality of behavior models includes user gestures associated with using the mobile device.

3. The method of claim 1, wherein the plurality of user gestures associated with using the mobile device includes at least one of a tap to select, a swipe, a scroll, and a pinch.

4. The method of claim 1, wherein the behavior model of a plurality of behavior models includes: at least one of unlocking the mobile device, entering data into the device, answering a call on the mobile device, patterns with respect to the keystrokes that a certain operator makes to enter input into the device, and biometrics.

5. The method of claim 1, wherein the biometrics include at least one of heart rate, respiration rate, and skin conductivity.

6. The method of claim 1, wherein the baseline application access model is updated on a plurality of baseline application models from other users.

7. The method of claim 1, wherein acquiring dynamic data associated with the mobile device further includes:
acquiring raw dynamic sensor data from the mobile device for a selected duration;
extracting time and frequency domain features in the raw dynamic sensor data; and
building at least one behavior model of a plurality of behavior models by applying extracted time and frequency domain features to a learning algorithm.

8. The method of claim 7, wherein the dynamic data includes at least one of rotational accelerations, rotational rates, rotation, translational accelerations, translational velocities, and position data, associated with the mobile device.

9. The method of claim 1, wherein the position data is based on at least one of accelerometer, gyroscope and GPS data.

10. The method of claim 1, further including that the baseline application access model is an aggregate of a plurality the baseline application access models associated with a plurality of user devices.

11. The method of claim 10, wherein the baseline application access model, is aggregated on a remote server based on a plurality the baseline application access models associated with a plurality of user devices.

12. The method of claim 1, further including that the user detection model, is an aggregate of a plurality user detection models.

13. (canceled)

14. The method of claim 1, wherein the at least one behavior model is independent of user application touch sensor data.

15. The method of claim 1, further including establishing a trust score associated with the determining, the trust score providing a weighting of how closely the measured behaviors match the trained behaviors in the user detection model.

16. The method of claim 15, wherein a trust score greater than a selected threshold indicates a sufficient match for authentication.

17. The method of claim 1, further including taking security precautions with the user device if the user is identified as not an authorized user.

18. The method of claim 1, wherein the security precautions include at least one of sounding an alarm, locking the mobile device, placing a call to law enforcement, shutting the mobile device off.

19. The method of claim 1, further including acquiring data from a wearable device and establishing at least one behavior model of the plurality of behavior models generated based on the data associated with the wearable device.

20. The method of claim 1, wherein the data associated with the wearable device is biometric data associated with the user.

21. A system for continuous user authentication on a mobile device, the system comprising:
a user device;
a server, the server operably connected to the user device;
at least one of the server and the user device configured to execute a method of continuous user authentication on the mobile device, the method comprising:
establishing a baseline application access model, the baseline application access model based on at least one behavior model of a plurality of behavior models generated based on acquiring dynamic data associated with the mobile device;
deploying at least one of a training app or a baseline application model to the mobile device;
generating user detection model, the user detection model based on at least one baseline application access model and at least one behavior model of the plurality of behavior models updated by dynamic data associated with the mobile device collected while an authorized user employs the mobile device to access an application;
if the user detection model was remotely generated, deploying the user detection model to the mobile device;
measuring further dynamic data to predict behaviors in the user detection model while a user operates the mobile device; and
determining if a user is an authorized user based on how closely measured behaviors match the trained behaviors in the user detection model.
